(19) United States
(12) Patent Application Publication
(10) Pub. No.: US 2016/0046843 A1
(43) Pub. Date: Feb. 18, 2016

(54) ADHESIVE COMPOSITION FOR INKJET PRINTING

(71) Applicant: R.R. DONNELLEY & SONS COMPANY, Chicago, IL (US)

(72) Inventors: Pamela Geddes, Alden, NY (US); Michael Carson, JR., Tonawanda, NY (US); Sopheap Ros, Grand Island, NY (US)

(21) Appl. No.: 14/825,630

(22) Filed: Aug. 13, 2015

Related U.S. Application Data
(60) Provisional application No. 62/036,953, filed on Aug. 13, 2014.

(51) Int. Cl. C09J 133/02; C09J 123/08; C08K 5/1515; B41J 2/01

(52) U.S. Cl. CPC C09J 133/02; B41J 2/01; C09J 123/0869; C08K 5/1515

(57) ABSTRACT

An adhesive composition includes a polymer, a cosolvent, a surfactant, and the balance comprising water. The adhesive composition has a viscosity such that the adhesive composition can be applied to a substrate using an inkjet printhead.

### CROSS REFERENCE TO RELATED APPLICATIONS

This application claims the benefit of Provisional Application No. 62/036,953, filed Aug. 13, 2014.

### REFERENCE REGARDING FEDERALLY SPONSORED RESEARCH OR DEVELOPMENT

Not applicable

### SEQUENTIAL LISTING

Not applicable

FIELD OF DISCLOSURE

### The present subject matter relates to generally to adhesive compositions, and more particularly, to adhesive compositions used in an inkjet printing system.

### BACKGROUND

Inkjet printing technology provides printers with variable capability. There are three main inkjet technologies: thermal, i.e. bubble jet, piezoelectric, and continuous. In each, tiny droplets of ink are ejected (i.e., sprayed) onto a page. In a thermal jet printer, a heat source vaporizes ink to create a bubble. The expanding bubble causes a droplet to form, and the droplet is ejected from the print head. Piezoelectric technology uses a piezo crystal located at the back of an ink reservoir. Alternating electric potentials are used to cause vibrations in the crystal. The back and forth motion of the crystal is able to draw in enough ink for one droplet and eject that ink onto the paper. In a continuous inkjet system, the nozzles are continuously firing and an electrode associated with each nozzle deflects the drops to a gutter for collection when the nozzle is not to print. When a nozzle is to print the electrode is deactivated and the drop will pass to the substrate.

In general, adhesives include any materials that bind together two surfaces. The adhesive qualities require specific handling and application thereof. In conventional applications, an adhesive is applied to one of the two surfaces through a coating technique or the application of a film resin. Adhesives are not typically applied to a surface using an inkjet print head due to the small size of the inkjet nozzle, the tackiness of the adhesive, and its overall high viscosity. However, use of an inkjet print head would allow greater precision in the deposition and location of an adhesive on a surface. Inkjet printing would also enable variation in patterns in relatively short manufacturing runs. Such precision and variation is not currently available through conventional application methods.

### SUMMARY

According to one aspect, an adhesive composition includes a polymer, a cosolvent, a surfactant, and water. The adhesive composition has a viscosity such that the adhesive composition can be applied to a substrate using an inkjet printhead.

In another embodiment, an adhesive composition adapted to be applied using an inkjet printhead includes from about 5% to about 30% by weight of a polymer, from about 2% to about 30% by weight of a cosolvent, and from about 0.2% to about 3% by weight of surfactant, and the balance comprising water. The adhesive composition has a viscosity such that the adhesive composition can be jetted by the inkjet print head.

In another embodiment, a device for use in an inkjet print operation comprises a housing, a series of ejection nozzles mounted within the housing, each ejection nozzle capable of ejecting a drop on demand, and a source of an adhesive composition communicating with the nozzles. The adhesive composition comprises a polymer, a cosolvent, a surfactant, and water.

Other aspects and advantages will become apparent upon consideration of the following detailed description and the attached drawings wherein like numerals designate like structures throughout the specification.

### DETAILED DESCRIPTION

An adhesive composition of the present application includes a polymer, a cosolvent, a surfactant, and water. The adhesive composition has a viscosity such that the adhesive composition can be applied to the receiver substrate using an inkjet print head. The receiver substrate moves through the system at a speed between about 5 ft/min (0.03 m/s) and about 100 ft/min (0.51 m/s).

Viscosity is shown in centipoise (cP) units which are equivalent to millipascal-seconds (mPa-s). The desired viscosity depends in part on the requirements of the inkjet print head to be used. For example, using a Kyocera KJ4B Printhead, manufactured by the Kyocera Corporation (Kyoto, Japan), the viscosity may range from about 1.0 cP (mPa-s) to about 20.0 cP (mPa-s), preferably from about 4.0 cP (mPa-s) to about 6.0 cP (mPa-s). Using a Dimatix printhead manufactured by Fuji (Tokyo, Japan), the viscosity may range from about 1.0 cP (mPa-s) to about 20.0 cP (mPa-s), preferably about 10 cP (mPa-s) to about 14 cP (mPa-s).

In one embodiment, the adhesive composition may include about 5% to about 30%, preferably from about 6% to about 20%, and most preferably from about 8% to about 15%, by weight of a polymer; about 2% to about 30%, preferably from about 4% to about 28%, and most preferably from about 5% to about 15%, by weight of a cosolvent; about 0.2% to about 3%, preferably from about 0.5% to about 2%, and most preferably about 0.5% to about 1.75%, by weight of a surfactant; and the balance comprising water.

The polymer may be a hot melt adhesive that is activated by the application of heat and pressure. Specifically, the adhesive composition is jetted onto the receiver substrate in a pattern. A majority of the water is vaporized once the adhesive composition is on the receiver substrate. The receiver substrate onto which the adhesive composition is jetted may be maintained at an elevated temperature from about 25 degrees Celsius to about 200 degrees Celsius, to promote vaporization of the water. The receiver substrate then contacts a layer of the material carried by a carrier substrate. During the transfer process, sufficient heat and pressure are applied to the adhesive composition to activate the polymer such that a bond is formed by the adhesive composition between the receiver substrate and the material. The amount of heat and pressure required to activate the polymer depends on the properties of the polymer. In one embodiment, the applied heat may range from approximately 60 degrees Celsius to approximately 160 degrees Celsius, and the applied pressure may range from about 10 psi (68.9 kPa) to about 25 psi (172 kPa). As the carrier substrate separates from the receiver substrate, the material bonded to the receiver substrate remains on the receiver substrate in the pattern of the jetted adhesive composition, while the remainder of the material remains on the carrier substrate.

The polymer of the adhesive composition may be an ethylene acrylic acid copolymer. In one embodiment, the polymer has a weight average molecular weight of less than about 50,000 g/mol, preferably between about 5,000 and about 30,000 g/mol, and more preferably ranging from about 15,000 to about 20,000 g/mol. In other embodiments, it may be preferred to use a polymer having a higher molecular weight if, for example, the adhesive composition is subjected to a subsequent lamination process(es). Such further lamination may interfere with the adhesive qualities of the adhesive composition. Further, the polymer is water-dispersible. The melt point of the polymer may range from about 25 degrees Celsius to about 150 degrees Celsius, preferably about 75 degrees Celsius to about 95 degrees Celsius, although this characteristic of the polymer may be modified depending on a number of factors such as the substrate material and the amount of heat and pressure applied during the transfer process, among others. Two suitable hot melt adhesives include Michem® Prime 4990R and Michem® Prime MP4983-40R by Michelman (Cincinnati, Ohio), although other hot melt adhesives may be used.

Alternate polymers that maybe used are polyester, maleic anhydride, ethylene-vinyl acetate, terpolymers of ethylene-vinyl acetate-maleic anhydride, polyurethanes, copolymers of vinyl vinyl-acetate and ethylene, epoxies, polyimides, polyamides, silanes, polypropylene, styrene-maleic anhydride copolymers, acrylic resins, styrenated acrylic resins, polyvinyl alcohol, cellulosic, styrenated butadiene, styrenated-isoprene-styrene and the like.

Waxes maybe used to adjust the tack, dry melt point and, adhesion properties of the adhesive. Examples of waxes that maybe used are paraffin, candelilla, montan, carnauba, fischer-tropsch, ethylene bis-stearamide, microcrystalline, alpha olefins, ceresin and the like.

Tackifiers are used to adjust softening points, cohesive strength, adhesive strength, viscosity. Examples of tackifiers are rosin esters, aliphatic hydrocarbons, hydrogenated hydrocarbons, terpene phenolics, and pure monomer resins.

The cosolvent of the adhesive composition provides humectancy in the printhead and increases or decreases the viscosity of the composition to allow for inkjet printing. One or more cosolvents may act as a humectant and/or as a viscosity modifier. Examples of suitable cosolvents include 1-(2-hydroxyethyl)-2-pyrrolidone, alcohols, polyols, glycerols, or glycols, and other organic compounds.

The surfactant(s) decreases the surface tension of the adhesive composition in order for the composition to be jettable. Any type of surfactant may be useful to include in the adhesive composition to impart the desired properties including anionic, nonionic, cationic, or other types of surfactants. The surfactant may be a nonionic ethylene oxide, a polyacrylate-based surface additive, or other similar compounds. Examples of suitable surfactants include Surfynol® 400 series surfactants, including Surfynol® 420, 440, 465, and 485, by Air Products (Allentown, Pa.) or BYK-381 by Byk (Wallingford, Conn.). Specifically, the Surfynol® 400 series surfactants are produced by reacting various amounts of ethylene oxide with 2,4,7,9-tetra-methyl-5-decyne-4,7-diol (Air Products' Surfynol® 104), a nonionic molecule with a hydrophilic section in the middle of two symmetric hydrophobic groups.

Further, the adhesive composition may include a combination of surfactants. In one embodiment, the adhesive composition includes approximately 0.76% by weight of Surfynol® 465 and approximately 0.25% by weight of Surfynol® 440. In this embodiment, the Surfynol® 440 lowers the surface tension of the adhesive composition to enable inkjet printing, but such surfactant has a low HLB (hydrophilic/lipophilic balance). The Surfynol® 465 is added to disperse and stabilize the Surfynol® 440 in the water.

In another embodiment, a single surfactant may be sufficient in the adhesive composition for jetting. Such example includes the use of Surfynol® 465 or Surfynol® 440 at a weight % ranging from 0.25% to 1%, preferably 0.5% to 0.75%.

Additionally, the adhesive composition may include a rheological modifier such as a carbopolymer or gelling agent to increase the viscosity of the adhesive composition. In one embodiment, the rheological modifier may be an alkali emulsion on an acrylic backbone such as Rheolate® 125, and in another embodiment, the modifier can be polyether polyurethane such as Rheolate® 212, both by Elementis Specialties (East Windsor, N.J.).

A pH modifier may also be included in the adhesive composition to comply with the requirements of the inkjet printhead. The selection of the pH modifier will depend on the other components of the adhesive composition. One example of a suitable pH modifier is dimethylethanolamine.

A colorant may also be included. The colorant may be any conventional dye or pigment commercially available. The use of a dye may be preferred, as such colorant does not include particulate matter and therefore will not affect the adhesive qualities of the composition. In other embodiments, a pigment may be used as desired. An example of a suitable colorant is an azo dye such as Bayscript® Magenta BB by Lanxess (Pittsburgh, Pa.).

Additional contemplated components in the adhesive composition include a solvent, a preservative, an anticurl agent, a humectant (e.g. propylene glycol), a wetting agent such as BYK-381 by Byk (Wallingford, Conn.), a biocide, a colorant, a surfactant, a polymer, a defoaming agent, a leveling agent, a salt, an inorganic compound, an organic compound, water, a pH modifier, and/or any combination thereof.

The adhesive composition may be jetted from a jet system containing a series of inkjet cartridges (e.g., bubble jet cartridges, thermal cartridges, piezoelectric cartridges, continuous inkjet systems, etc.). A bubble jet may emit a drop of liquid when excited by a heater. A piezoelectric system may eject a drop of liquid when excited by a piezoelectric actuator. The drop is emitted from a tiny hole in the jet cartridges. The cartridges may contain any number of holes. Commonly, jet cartridges can be found with six hundred holes, often arranged in two rows of three hundred. The jet units may be known print cartridge units such as those manufactured by Hewlett Packard, Lexmark, Spectra, Canon, etc. An example of a jet cartridge and jet head is described in Murakami et al. U.S. Pat. No. 7,240,998, which is incorporated herein by reference. Continuous systems are available from Kodak under the trade name Versamark®.

The jet system or any of the jet systems as disclosed herein may be used to emit the adhesive composition from the inkjet cartridge(s). The adhesive composition may be jetted from one print head moving along the width of the substrate, or from multiple print heads jetting onto the substrate in-line. The substrate may move continuously through the print unit as the adhesive composition is jetted, or may remain static during jetting. The adhesive composition may be jetted by multiple passes of the print head(s) in order to obtain the desired thickness. In some embodiments, the thickness may be up to about 10 microns (μm), preferably between about 2 μm and about 7 μm, and most preferably between about 4 μm and about 6 μm. This thickness may be obtained by making up to 10 passes, preferably up to about 5 passes, and more preferably between about 3 passes and 5 passes, of the printing unit over the receiver substrate, although the number of passes is dependent on various factors such as, for example, selection of the print head type, jetting performance, fluid solids content of the adhesive composition, mass flow rate, the speed of the substrate through the printing system, and the material of the receiver substrate.

Jetting performance is evaluated by drop size, nozzle wet-out, satellite formation or tailing (described in greater detail below), mass flow rate, and frequency response. Mass flow rate refers to the consistency of the flow through the nozzles over a period of time. The frequency response refers to the consistency of the performance over a range of jetting frequencies.

The jet system may be used to “print” or jet the adhesive composition having a shape or pattern onto the substrate. For example, a shape controller may receive shape data from a data system. The shape data may represent the shape to be printed. The shape data may include variable shape data that changes relatively frequently, semi-fixed shape data that changes less frequently, fixed shape data that remains static, and any combination of variable, semi-fixed, and fixed shape data. Some or all of the shape data may be stored as binary data, bitmap data, page description code, or a combination of binary data, bitmap data, and page description code. For example, a page description language (PDL), such as PostScript or Printer Command Language (PCL), may be used to define and interpret shape data in some embodiments. The data system may then electronically control jet system to print the shape represented by some or all of the different types of shape data (or any portion thereof) onto the substrate. In some embodiments, a vacuum source or heat source may be positioned next to or near jet system.

As is customary in the inkjet production art, any type of cleaning system may be utilized to clean the inkjet print heads.

Any of the systems or compositions described herein may be modified to allow formation of different drop sizes of the adhesive composition. The drop size should be consistent to form a continuous, consistent layer of jetted adhesive composition.

Any of the systems described herein may be modified to allow formation of different drop sizes of the adhesive composition. In general, a higher resolution grid, that is a grid with 300 dpi or greater, along with matched drop size improves collection of the adhesive composition. Also, as the dpi of the grid increases, the size of the drops that is most efficacious general are smaller. A larger drop size is more susceptible to forced wetting of areas to be imaged. This forced wetting can cause a decrease in shape quality due to a reduction in print density. Such forced wetting can be minimized by the addition/removal of one or more constituents and/or changing or adjusting one or more physical properties of the adhesive composition. For example, reducing certain surfactants may reduce ghosting while utilizing, adding, and/or substituting other surfactants may also improve shape quality.

Properties of the adhesive composition and of the substrate may be varied to achieve a desirable interaction between the pattern that is printed with the jet system and the substrate. In particular, manipulating the viscosity of the adhesive composition to 1 to 20 cP (mPa-s) prevents satellite droplet and/or aerosol formation while enabling reproducible drop ejection. Satellite drops can cause ghosting whereby the adhesive composition migrates outside of the desired area during printing. It is important that the viscosity of the adhesive composition be maintained at a value less than 20 cP (mPa-s) to allow for the adhesive composition to be emitted from a piezo jet head. Other chemical and/or materials science properties might be utilized to reduce or eliminate this effect. The adhesive composition may also include a pseudoplastic fluid that changes viscosity under pressure or agitation. Manipulating the surface tension of the adhesive composition can also aid uniform droplet formation, minimize or eliminate nozzle plate wetting, and improve spreading on the substrate.

Another process variable is the material onto which the adhesive composition is jetted. The surface to which the adhesive composition is to be applied may be suitably prepared, processed, treated, machined, textured, or otherwise modified, if necessary or desirable. The receiver substrate may be coated or uncoated paper, plastic, polyethylene, a metal, a label stock material, or other similar materials.

In some embodiments, the adhesive composition may be jetted onto the receiver substrate multiple times during a manufacturing process. In one embodiment, a first layer of the adhesive composition jetted atop of the receiver substrate adheres a first layer of first material such as a metal foil or an insulating material thereto in a first pattern. The metal foil may comprise aluminum, silver, copper, gold, a metal alloy, and the like. The insulating layer such as an acrylic polymer, a polyester, an acrylic copolymer, or any other material that provides a sufficient dielectric constant. During the transfer process, the first layer of material carried by a carrier substrate contacts the receiver substrate, during which heat and pressure is applied to activate the polymer of the adhesive composition. The carrier substrate then separates from the receiver substrate, and the first layer of material adheres to the receiver substrate in the first pattern. Subsequently, a second layer of the adhesive composition may be jetted atop the first pattern of the first material in a second pattern. The second layer may adhere a second layer of a second material such as a metallic foil or insulating material thereto in a second pattern during a further transfer process. A third material may be jetted, placed, soldered, or otherwise disposed atop of one or more of the first and second layer of the adhesive composition and the first or second layers of respective first or second materials. In some example manufacturing processes, the first and second layers of the adhesive compositions may include polymers having different molecular weights. For example, the molecular weight of the first layer of the adhesive composition may be higher than the molecular weight of the second layer of the adhesive composition so that the first layer may withstand the subsequent lamination (i.e., heat and pressure) applied during the further transfer process.

A still further option is to modulate/control the temperature of one or more process parameters. For example, one might elevate the temperature of the adhesive composition upon application thereof to the substrate to improve adherence and facilitate dispensing thereof. Alternatively, or in addition, the receiver substrate may initially be heated during application of adhesive composition to control adhesion, drop shape/size, and the like.

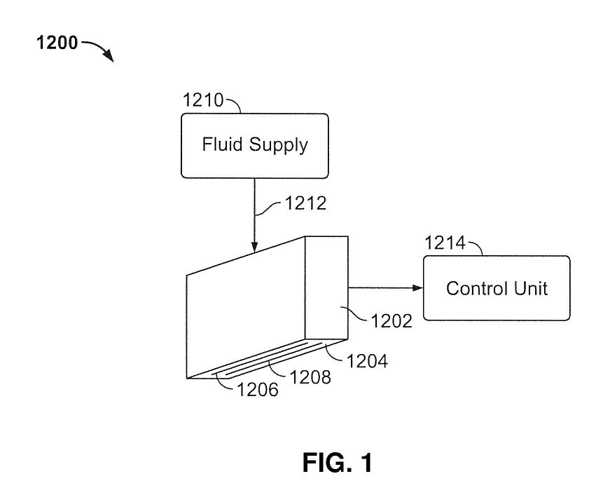

Referring to FIG. 1, an adhesive composition 1210 may be jetted using a device 1200 having a housing 1202 with a surface 1204. The surface 1204 has a plurality of jet nozzles 1206, 1208. In FIG. 1, two rows of nozzles 1206, 1208 are shown, although the device 1200 can have one or more rows of nozzles depending on the needed resolution. The housing 1202 includes a chamber (not shown) in communication with the nozzles 1206, 1208 and also in communication with a source of adhesive composition 1210 via a tube or other communication media 1212. The device 1200 is controlled by a control device 1214 that may be any suitable print controller well known to those skilled in the art.

The following example further illustrates the disclosure but, of course, should not be construed as in any way limiting its scope. It should be noted that the method of preparing the adhesive composition may be modified as necessary depending on the size of the batch. Percentage by weight is provided.

### EXAMPLE 1

10% ethylene acrylic acid copolymer (Michem® Prime 4990R)
15% 1-(2-Hydroxyethyl)-2-pyrrolidone
0.76% nonionic ethylene oxide (Surfynol® 465)
0.25% nonionic ethylene oxide (Surfynol® 440)
0.32% polyacrylate-based surface additive (BYK-381)
0.05% rheological modifier (Rheolate® 125)
0.05% azo dye (Bayscript® Magenta BB)
0.001% dimethylethanolamine
73.6% water

### EXAMPLE 2

10% ethylene acrylic acid copolymer (Michem® Prime 4983-40R)
10% Tetraethylene glycol
10% Propylene glycol
0.5% nonionic ethylene oxide (Surfynol® 465)
5% rheological modifier (Rheolate® 212)
69.5% water

### EXAMPLE 3

20% ethylene acrylic acid copolymer (Michem® Prime 4983-40R)
15% Tetraethylene glycol
13.4% Propylene glycol
0.75% nonionic ethylene oxide (Surfynol® 465)
50.89% water

### INDUSTRIAL APPLICABILITY

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. An aqueous adhesive comprising:
within a range of about 6 to about 20% by weight of a polymer;
within a range of about 4 to about 28% by weight of a cosolvent;
within a range of about 0.4 to about 2% by weight of a surfactant; and
within a range of about 50 to about 90% by weight of water, wherein the aqueous adhesive has a viscosity in the range of about 1 to about 20 mPa-s such that the aqueous adhesive can be applied to a surface in a layer using an ink jet print head.

2. The aqueous adhesive of claim 1, wherein the viscosity is in the range of about 4 to about 14 mPa-s.

3. The aqueous adhesive of claim 1, wherein the polymer is an ethylene acrylic acid copolymer.

4. The aqueous adhesive of claim 1, wherein the polymer has a weight average molecular weight in the range of 5,000 to about 30,000 g/mol.

5. The aqueous adhesive of claim 1, wherein the polymer as a melt point in the range of 75 to about 95 degrees Celsius.

6. The aqueous adhesive of claim 1, further comprising a rheological modifier.

7. The aqueous adhesive of claim 1, wherein the cosolvent is chosen from the group consisting of 1-(2-hydroxyethyl)-2-pyrrolidone, alcohols, polyols, glycerols, and glycols.

8. The aqueous adhesive of claim 1, wherein the surfactant is nonionic diol.

9. A device for use in a high speed variable print operation comprising:
a housing having at least one surface;
a series of ejection nozzles mounted on the one surface, each ejection nozzle capable of ejecting a drop on demand; and
a source of aqueous adhesive communicating with the nozzles, the aqueous adhesive comprising:
within a range of about 6 to about 20% by weight of a polymer;
within a range of about 4 to about 28% by weight of a cosolvent:
within a range of about 0.4 to about 2% by weight of a surfactant; and
within a range of about 50 to about 90% by weight of water, wherein the aqueous adhesive has a viscosity in the range of about 1 to about 20 mPa-s such that the aqueous adhesive can be applied to a surface in a layer using an ink jet print head.

10. The aqueous adhesive of claim 9, wherein the viscosity is in the range of about 4 to about 14 mPa-s.

11. The aqueous adhesive of claim 9, wherein the polymer is an ethylene acrylic acid copolymer.

12. The aqueous adhesive of claim 9, wherein the polymer has a weight average molecular weight in the range of 5,000 to about 30,000 g/mol.

13. The aqueous adhesive of claim 9, wherein the polymer as a melt point in the range of 75 to about 95 degrees Celsius.

14. The aqueous adhesive of claim 9, wherein the cosolvent is chosen from the group consisting of 1-(2-hydroxyethyl)-2-pyrrolidone, alcohols, polyols, glycerols, and glycols.

15. The aqueous adhesive of claim 9, wherein the surfactant is nonionic diol.

16. A method for high speed variable printing comprising the steps of:
providing an aqueous adhesive, the aqueous adhesive comprising:
within a range of about 6 to about 20% by weight of a polymer;
within a range of about 4 to about 28% by weight of a cosolvent:
within a range of about 0.4 to about 2% by weight of a surfactant; and
within a range of about 50 to about 90% by weight of water, wherein the aqueous adhesive has a viscosity in the range of about 1 to about 20 mPa-s; and
jetting the aqueous adhesive onto a substrate in a first layer.

17. The method of claim 16, the method further comprising the step of jetting the aqueous adhesive in a plurality of further layers.

18. The method of claim 16, wherein the polymer is an ethylene acrylic acid copolymer.

19. The method of claim 16, the method further comprising the step of jetting the aqueous adhesive onto the substrate to adhere a metal foil.

20. The method of claim 16, the method further comprising the step of applying heat and pressure to the aqueous adhesive.
